(19) United States
(12) Patent Application Publication
(10) Pub. No.: US 2026/0003147 A1
(43) Pub. Date: Jan. 1, 2026

(54) EASY-TO-ACCESS FEATURE(S) FOR THIN-WALL OPTICAL CORE SUBUNIT

(71) Applicant: CORNING RESEARCH & DEVELOPMENT CORPORATION, Corning, NY (US)

(72) Inventors: Sergey Vladimirovich Chernykh, Berlin (DE); Peter Stuart Niehoff, Connelly Springs, NC (US)

(21) Appl. No.: 19/332,426

(22) Filed: Sep. 18, 2025

Related U.S. Application Data
(63) Continuation of application No. PCT/US2024/020344, filed on Mar. 18, 2024.
(60) Provisional application No. 63/454,365, filed on Mar. 24, 2023.

(51) Int. Cl. G02B 6/44

(52) U.S. Cl. CPC G02B 6/4431

(57) ABSTRACT

An optical fiber cable is provided. Embodiments of the disclosure relate to an optical fiber subunit for an optical fiber cable. The optical fiber subunit includes a membrane having an inner surface and an outer surface in which the inner surface defines a central passage. The subunit further includes an access feature disposed in the central passage and attached to the inner surface of the membrane. In various embodiments, the access feature includes a coating to provide enhanced attachment to the membrane. Also disclosed are embodiments of an optical fiber subunit having one or more subunits disposed within a central bore of a cable jacket and embodiments of a method of manufacturing a subunit for an optical fiber cable.

### CROSS-REFERENCE TO RELATED APPLICATION

This application is a continuation of International Patent Application No. PCT/US2024/020344, filed on Mar. 18, 2024, which claims the benefit of priority of U.S. Provisional Application No. 63/454,365, filed on Mar. 24, 2023, the content of which is relied upon and incorporated herein by reference in its entirety.

### BACKGROUND

The disclosure relates generally to optical fiber cables and, in particular, to optical fiber cables having subunits with access feature(s) attached and/or adhered to the thin-wall subunit membrane. Optical fibers are used to transmit data optically between various points in a network. Such optical fibers may be arranged in cables originating at data hubs, and the cables may include branches that drop at various locations to deliver data to nodes in the network. A variety of cable designs exist that provide such branching within a transmission network. In order to provide branches to an optical fiber cable, it is often necessary to provide access to the cable core to allow for splicing of branching units to subunits of the optical fiber cable.

### SUMMARY

In one aspect, embodiments of the present disclosure relate to an optical fiber subunit. The optical fiber subunit includes a membrane having an inner surface and an outer surface. The inner surface of the membrane defines a central passage that extends along a longitudinal axis of the optical fiber subunit. At least one optical fiber is disposed in the central passage such that the membrane surrounds the at least one optical fiber. An access feature extends along the longitudinal axis of the optical fiber subunit and is disposed in the central passage. The access feature is attached to the inner surface of the membrane.

In another aspect, embodiments of the present disclosure relate to an optical fiber cable. The optical fiber cable includes a cable jacket having an exterior surface and an interior surface. The exterior surface defines an outermost surface of the optical fiber cable. The interior surface defines a central bore extending along a longitudinal axis of the optical fiber cable. At least one subunit is disposed within the central bore. Each of the at least one subunits includes a membrane having an inner surface and an outer surface. The inner surface of the membrane defines a central passage that extends along a longitudinal axis of the optical fiber subunit. The subunit further includes at least one optical fiber and an access feature. The at least one optical fiber and the access feature are disposed in the central passage such that the membrane surrounds the at least one optical fiber and the access feature. The access feature is attached to the membrane.

According to a further aspect, embodiments of the disclosure relate to a method of manufacturing a subunit. In the method, a membrane is extruded around a bundle of a plurality of optical fibers and an access feature while the access feature is maintained separate from the bundle of the plurality of optical fibers to form a subunit. Further in the method the access feature is attached to an inner surface of the membrane.

Additional features and advantages will be set forth in the detailed description that follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding and are incorporated in and constitute a part of this specification. The drawings illustrate one or more embodiment(s), and together with the description serve to explain principles and the operation of the various embodiments.

### BRIEF DESCRIPTION OF THE DRAWINGS

FIG. 1 is a cross-sectional view of the cable of an optical fiber cable according to an exemplary embodiment.

FIG. 2 is a detailed cross-sectional view of a subunit of the cable of FIG. 1 according to an exemplary embodiment.

FIG. 3 is a detailed cross-sectional view of a subunit of the cable of FIG. 1 according to another exemplary embodiment.

FIG. 4 depicts a flow diagram of a method of forming an easy to access thin-wall subunit for an optical fiber cable, according to an exemplary embodiment.

FIG. 5 is a perspective view of an insert for an extrusion tool used in forming an easy to access thin-wall subunit for an optical fiber cable, according to an exemplary embodiment.

### DETAILED DESCRIPTION

Referring generally to the figures, various embodiments of an optical fiber cable having subunits with access feature(s) attached to a surrounding membrane are shown. The optical fiber cable includes optical fiber subunit(s) with at least one optical fiber or groups of optical fibers surrounded by thin-walled membranes. Applicant has found that it is desirable to make the membrane of the subunit very thin so that the subunit is configurable into multiple shapes to fit in an optical fiber cable core. Additionally, Applicant has found that it is desirable to provide easy access to the optical fibers within the subunit. In certain circumstances, access is provided by making the membrane tearable by hand through the use of compounds such as fillers in the membrane material. However, such filled membrane materials present additional undesirable material limitations (e.g., processing stability, thickness, etc.). To provide accessibility to the optical fibers in the membranes without need for specialized equipment and to avoid potential damage to the optical fibers as the membrane is opened, an access feature, such as a rip cord is attached to the wall of the membrane according to the present disclosure. In various specific embodiments, the access feature includes a coating to provide adhesion to the membrane.

In contrast to the subunit discussed herein, many optical fiber cables include access features either embedded in the wall of the membrane (e.g., in cable jackets, buffer tubes, etc.) or positioned loosely and/or freely within the passageway formed by the membrane. As a user opens a subunit membrane with an access feature positioned loosely or freely, a force and/or load may be applied to the access feature, and because the access feature is adjacent or engaged with the optical fibers, damage to the optical fibers can occur. Applicant believes the positioning and attachment of the access feature discussed herein allows for a thin membrane that provides easy access to the optical fibers with reduced risk of damaging the optical fibers during opening of the subunit. In other words, when a user opens the subunit, the force and/or load is applied directly to the subunit without loading the optical fibers within the subunit.

Additionally, as will be discussed in greater detail below, in various embodiments when the access feature is formed from a low shrink material, the access feature provides additional benefits to the subunit. For example, because the access feature is attached to the subunit membrane, Applicant believes any dimensional changes to the subunit and/or membrane caused by thermal cycling (e.g., from environmental temperature changes) are minimized. Further, when the access feature is formed from a material with a high modulus, Applicant has found the access feature provides extensional axial strength while maintaining flexibility of the optical cable.

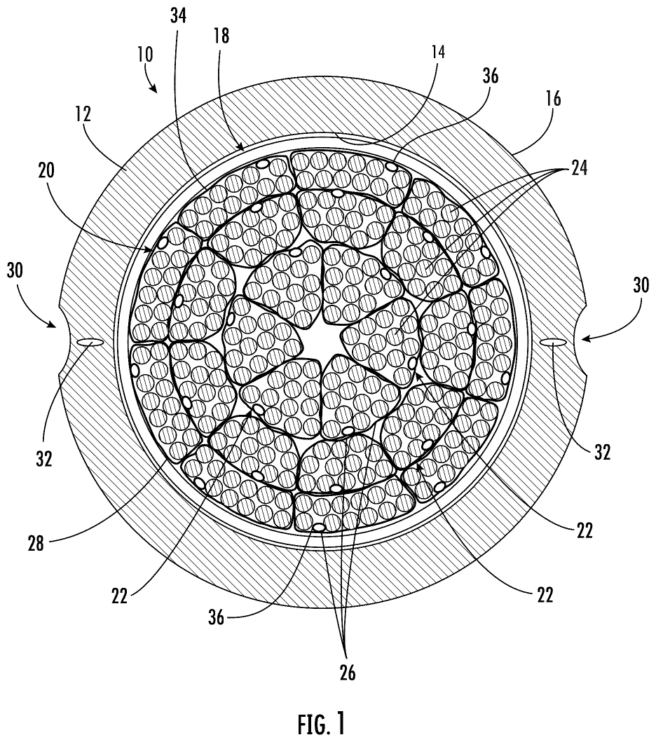

Referring to FIG. 1, various aspects of an optical fiber cable 10 are shown, according to an exemplary embodiment. Optical fiber cable 10 includes a cable jacket 12 having an interior surface 14 and an exterior surface 16. The interior surface 14 of optical fiber cable 10 defines a bore, shown as central bore 18 that extends along a longitudinal axis of the optical fiber cable 10. Disposed within the central bore 18 of the optical fiber cable 10 is cable core 20 including at least one subunit 22. In various embodiments, cable core 20 includes a plurality of subunits 22 positioned within central bore 18. Each subunit 22 includes at least one optical fiber 24 surrounded by a membrane 26. In various specific embodiments, each subunit 22 includes a plurality of optical fibers 24. The membrane 26 is a thin and flexible sheath that allows for the subunit 22 to be reconfigured into a variety of different shapes. In various specific embodiments, the membrane 26 and/or subunit 22 has a generally circular shape. In other embodiments, the flexibility of the membrane allows the subunit 22 to change shape, e.g., flatten out, bunch up, or bend, as necessary to fill space within the cable core 20 in contrast to rigid buffer tubes used in other cable designs.

In one or more embodiments, the optical fiber cable 10 further includes a binder 28 provided around the subunits 22, in particular disposed between the subunits 22 and the cable jacket 12. In one or more embodiments, the binder 28 is a polymer film or wrap provided around the subunits 22, which may hold the subunits 22 together in a stranded configuration (such as S-stranded, Z-stranded, or SZ-stranded). In one or more embodiments, the optical fiber cable 10 includes one or more of a water blocking material (e.g., tapes, yarns, powders), a lubricant, a friction-enhancing material, and an access feature (e.g., ripcords or preferential tear features, such as a strip of dissimilar polymer in the cable jacket 12). In one or more embodiments, the optical fiber cable 10 may include strength elements, such as glass-reinforced plastic rods, embedded in the cable jacket 12.

In various embodiments, the cable jacket 12 includes tactile locator features 30. In the embodiment depicted, the tactile locator features 30 comprise diametrically arranged depressions defined by the exterior surface 16 of the cable jacket 12. However, in one or more other embodiments, the tactile locator features 30 comprise diametrically arranged bumps defined by the exterior surface 16 of the cable jacket 12. The tactile locator features 30 assist a user in opening the cable 10 by guiding the user to the location of access features 32. In the embodiment of the optical fiber cable 10, the access features 32 are strips of dissimilar polymer embedded in the polymer of the cable jacket 12. For example, the cable jacket 12 may substantially comprise polyethylene, and the dissimilar polymer of the access feature 32 may be polypropylene. The immiscibility of polyethylene cable jacket 12 and the polypropylene access features 32 prevents a strong bond from forming between the cable jacket 12 and the access features 32, allowing for a user to tear through the cable jacket 12 in the region of the access features 32. Further, once opened at the access features 32, the cable jacket 12 can be split along its length along the access features 32.

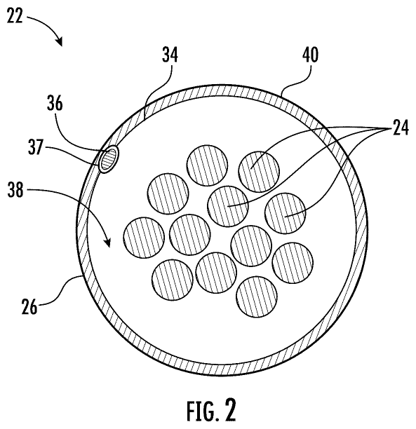

Referring to FIG. 2, a detailed cross-sectional view of a subunit 22 that can be utilized with optical fiber cable 10 is shown according to an exemplary embodiment. Membrane 26 of subunit 22 includes an inner surface 34 and an outer surface 40. Inner surface 34 defines a passageway, shown as central passage 38 that extends along a longitudinal axis of the subunit 22. In various specific embodiments, the longitudinal axis of the optical fiber subunit 22 extends in a generally parallel orientation to the longitudinal axis of the optical fiber cable 10.

At least one optical fiber 24 is disposed in central passage 38 of optical fiber subunit 22 such that membrane 26 surrounds the at least one optical fiber 24. In various specific embodiments, a plurality of optical fibers 24 are disposed in central passage 38 of optical fiber subunit 22 such that membrane 26 surrounds the plurality of optical fibers 24. Optical fiber subunit 22 further includes a least one access feature, shown as a rip cord 36. In various specific embodiments, the rip cord 36 comprises a yarn, thread, or roving having a coating 37.

Rip cord 36 extends along the longitudinal axis of the optical fiber subunit 22. Rip cord 36 is disposed in the central passage 38 and attached to the inner surface 34 of membrane 26. Once opened at the rip cord 36, the membrane 26 can be split along its length along the rip cord 36. In various embodiments, the rip cord 36 includes a coating 37 along at least a portion of a length of the rip cord 36 to adhere the rip cord 36 to the membrane 26. In one or more embodiments, the coating 37 is a continuous coating (i.e., extends along the entire rip cord 36). In one or more embodiments, the coating 37 is an intermittent coating that extends along various portions of the length of the rip cord 36.

When the membrane 26 is extruded, the rip cord 36 is attached to inner surface 34 of membrane 26 while membrane 26 is at a raised temperature (i.e., extrusion temperature). In particular, the rip cord 36 attaches to the inner surface 34 of the membrane through at least one of a physical interaction (e.g., mechanical interlock), an electrical interaction (e.g., Van der Waals forces), and a chemical interaction (e.g., chemical bond) such that the ripcord is permanently attached to the membrane 26. In embodiments in which it is included, the coating 37 on rip cord 36 may enhance the attachment of the rip cord 36 to the membrane 26.

A thickness of membrane 26 is defined between inner surface 34 and outer surface 38. A maximum thickness of membrane 26 is 0.12 mm or less, specifically 0.08 mm or less, and more specifically, 0.04 mm or less. In various embodiments, the membrane 26 has a thickness in a range from 0.08 mm to 0.12 mm, 0.04 mm to 0.08 mm, 0.02 mm to 0.04 mm. In such an embodiment, the thickness of membrane 26 is about 0.04 mm (i.e., 0.04 mm plus or minus 0.010 mm).

Further, in one or more embodiments, each subunit 22 includes a membrane 26 that is translucent or transparent, and the rip cord 36 is colored such that rip cord 36 is easily visible within subunit 22. In various embodiments, the membrane 26 is thin enough that the rip cord 36 can be felt through membrane 26 by a user that wishes to access or open subunit 22. In one or more embodiments, each subunit 22 includes a membrane 26 that is not translucent or not transparent, and the rip cord 36 is colored such that rip cord 36 is easily identifiable within subunit 22 relative to other components within the membrane 26, such as water blocking material (yarns, threads, etc.).

In one or more embodiments, rip cord 36 includes a coating 37 with water blocking properties. In a specific embodiment, the coating 37 is formed from a water swellable hot melt material. In such an embodiment, the use of a water blocking coating 37 on rip cord 36 decreases the number of water blocking yarns or the amount of water blocking powder positioned within membrane 26. In one or more embodiments, where one or more rip cords 36 and water blocking yarns or threads are included within a subunit 22, the rip cord 36 is colored such that an installer can identify the rip cord(s) 36 within subunit 22.

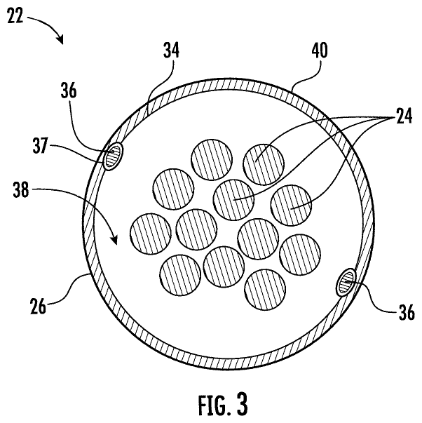

Referring to FIG. 3, a detailed cross-sectional view of a subunit 22 that can be utilized with optical fiber cable 10 is shown according to another exemplary embodiment. Optical fiber subunit 22 and membrane 26 includes two access features or rip cords 36 attached to inner surface 34 of membrane 26. The second rip cord 36 extends along the longitudinal axis of the optical fiber subunit 22 and is disposed in the central passage 38 and attached to inner surface 34 of membrane 26. In one or more such embodiments, the first rip cord 36 and the second rip cord 36 are substantially equidistantly spaced around the inner surface 34 of membrane 26. In other words, a first span of membrane 26 between the two rip cords 36 is substantially equal to a second span of membrane 26 between the rip cords 36. The generally opposed positioning of the rip cords 36 provides improved ease of opening or peeling membrane 26 when a user wants to access optical fibers 24. Notwithstanding, in one or more other embodiments, the rip cords 36 are not equidistantly spaced around the inner surface 34 of the membrane 26 and instead may have different spans of membrane 26 on either side of the rip cords 36.

In various embodiments, membrane 26 includes a plurality of rip cords 36, each rip cord 36 extends along the longitudinal axis of the optical fiber cable 10 and is bonded to inner surface 34 of membrane 26. In various specific embodiments, the optical fiber subunit 22 may include a different number of rip cords 36 (i.e., 3, 4, 5, etc.).

The coating 37 of the rip cord 36 that is configured to adhere the rip cord 36 to membrane 26 can be selected based on the material of the membrane 26 to promote a high level of attachment. In one or more embodiments, the coating 37 of the rip cord 36 is a polymer or copolymer comprising monomers that are also contained in the polymeric material of the membrane 26. For example, in one or more embodiments, when the membrane is formed from a polyethylene (PE) material the coating is an elastomeric copolymer of ethylene. Applicant believes the use of an elastomeric copolymer of ethylene provides both resistance to tensile, bending, and/or twisting while maintaining softness and flexibility against the optical fibers 24. In various embodiments, the coating is formed from at least one of ethylene acrylic acid (EAA), ethylene vinyl acid (EVA) copolymers, or a mixture of ethylene acrylic acid and ethylene vinyl acid copolymers.

In one or more embodiments, when membrane 26 is formed from a linear low-density polyethylene (LLDPE) resin (such as DOWLEX™ 2248G available from Dow, Inc., Midland, Michigan), coating 37 is formed from a hot melt adhesive having 15 wt. % of EVA and 25 wt. % of EAA copolymers.

As previously discussed, because the access feature or rip cord is attached to the subunit membrane 26, any dimensional changes to the subunit 22 and/or membrane 26 caused by thermal cycling are minimized by forming the rip cord 36 from a low shrink material. In one or more specific embodiments, rip cord 36 is formed from a low shrink polymer material. In one or more embodiments, the low shrink material has a shrinkage not greater than 4% when exposed to hot air at 190 degrees Celsius for 15 minutes with a 0.01 g/den tension load. In one or more embodiments, the low shrink material is configured to have a shrinkage not greater than 4% (as measured according to ASTM D4974).

In one or more embodiments, the rip cord 36 is formed from an ultra-low shrink polyester (such as Roblon ULS polyester 1100 dTex yarn available from Roblon, Frederikshavn, Denmark or MAX-Force™ HT 550 dTex yarn available from FibrXL Industrial, Richmond, Virginia). In one or more embodiments, the ultra-low shrink material has a shrinkage not greater than 2% when exposed to hot air at 190 degrees Celsius for 15 minutes with a 0.01 g/den tension load. In one or more embodiments, the ultra-low shrink material has a shrinkage not greater than 1% when exposed to hot air at 190 degrees Celsius for 15 minutes with a 0.01 g/den tension load. In one or more embodiments, the ultra-low shrink material is configured to have a shrinkage not greater than 2%, in particular not greater than 1% (as measured according to ASTM D4974). In various embodiments, rip cord 36 is formed from at least one of ultra-low shrink polyester, ultra high molecular weight polyethylene (UHMWPE), an aramid, liquid crystal polymer (“LCP,” such as Vectran® available from Avient Corporation, Avon Lake, Ohio), E-glass, or basalt.

Further, the rip cord 36 material is formed from a material that provides a tensile strength that allows for tearing of the membrane 26. In other words, the rip cord 36 is formed from a material not easily broken or ripped during the process of opening of subunit 22. In various embodiments, the rip cord 36 has a tensile strength in a range of 20 MPa to 201 MPa, in particular 30 MPa to 80 MPa, and most particularly 40 MPa to 60 MPa. In such an embodiment, the tensile strength of the rip cord 36 is about 50 MPa (i.e., 50 MPa plus or minus 5 MPa). In various embodiments, the rip cord 36 has a tenacity (breaking load/mass per unit length) in a range of 1 grams/denier to 50 grams/denier, in particular 5 grams/denier to 30 grams/denier.

Additionally, when the rip cord 36 is formed from a material with a high modulus, Applicant has found the rip cord 36 provides extensional axial strength while maintaining flexibility of the optical cable 10. In such embodiments, rip cord 36 acts not only as a rip cord, but also as a strength member for subunit 22. In one or more embodiments, rip cord 36 has an elastic modulus greater than 1 GPa, in particular greater than 10 GPa, and most particularly 50 GPa. In various embodiments, the rip cord 36 has an elastic modulus in a range of 2 GPa to 140 GPa, 40 GPa to 120 GPa, 60 GPa to 80 GPa. In such an embodiment, the elastic modulus of the rip cord 36 is about 60 GPa (i.e., 60 GPa plus or minus 10 GPa).

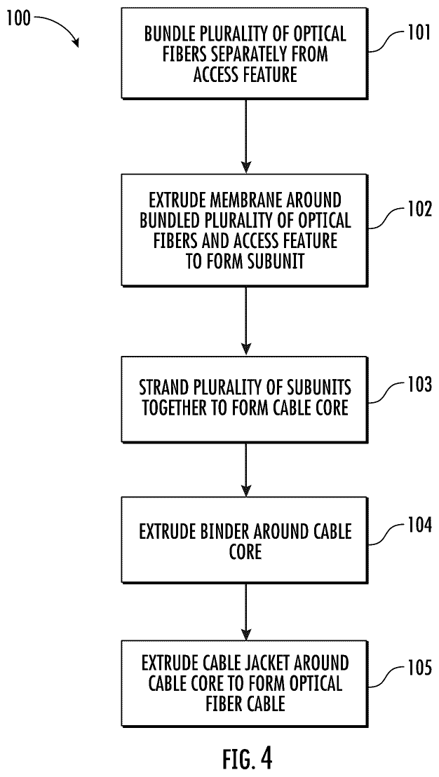

Having described the optical fiber cable 10, embodiments of a method for manufacturing an optical fiber cable 10 including subunit(s) 22 will be described in relation to the flow diagram of FIG. 4. In various embodiments, a method 100 of forming the subunits 22 involves providing a bundle of a plurality of optical fibers 24 and an access feature 36 in a manner that the access feature 36 is maintained separately from the bundle of the plurality of optical fibers 24 in a first step 101. The separation between the optical fibers 24 and access feature 36 prevents the access feature 36 and optical fibers 24 from becoming entangled during the simultaneous extrusion process.

A membrane 26 is extruded around the bundle of the plurality of optical fibers 24 and the access feature 36 to form the subunit 22 in a second step 102. As the membrane 26 is extruded, the access feature 36 is attached to the hot membrane 26 and specifically the inner surface 34. When the membrane 26 cools, the access feature 36 remains attached to membrane 26 such that a break line for the membrane 26 is created. In various embodiments, the subunit 22 includes a second access feature 36 such that the extruding step includes extruding the membrane 26 around the bundle of the plurality of optical fibers 24, the access feature 36, and the second access feature 36 with both the access feature 36 and second access feature 36 maintained separately from the bundle of the plurality of optical fibers 24.

In one or more embodiments of the method 100, a coating 37 is applied to the access feature(s) 36 before extruding the membrane 26. In various other embodiments, the access feature(s) 36 are pre-coated (e.g., by a supplier of the access features) or coated before the method 100 of forming the subunits 22 (e.g., on a separate processing line or on the same processing line immediately upstream). In various embodiments where the access feature(s) are coated, the access feature is attached to the inner surface 34 of the membrane 26 during the extruding of membrane 26. In other words, as membrane 26 is extruded the coating 37 on the access feature 36 sticks and/or non-permanently attaches to the inner surface 34 of membrane 26.

In one or more embodiments of the method 100, the subunits 22 are formed into a cable core 20 in a third step 103. In various embodiments, the subunits 22 extend straight along the longitudinal axis in the cable core 20, and in other embodiments, the subunits 22 are stranded (e.g., S-stranded, Z-stranded, or SZ-stranded) along the longitudinal axis in the cable core 20.

In one or more embodiments of the method 100, the binder 28 is optionally extruded around a plurality of subunits 22 and/or the cable core 20 in a fourth step 104. In a fifth step 105 of the method 100, a jacket such as cable jacket 12 is then extruded around the subunits 22 or binder 28, as the case may be. When the jacket is a cable jacket 12 with an interior surface 14 and an exterior surface 16, the exterior surface 16 is an outermost surface of the optical fiber cable 10. During extrusion of the cable jacket 12, the access feature 32 and the tactile locator features 30 may be formed in the cable jacket 12 through the use of specially-configured extrusion die-heads.

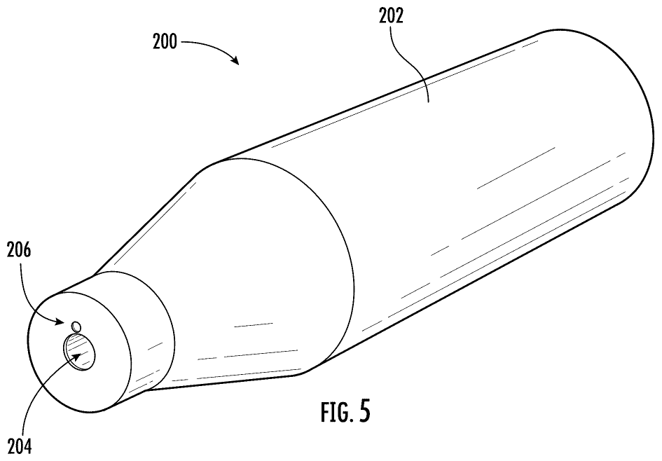

Referring to FIG. 5, a perspective view of an insert for an extrusion tool used in forming the subunit 22 for optical fiber cable 10 is shown according to an exemplary embodiment. A tool or insert 200 can be positioned in an extrusion tip prior to the extrusion and/or forming of the subunit(s) 22. Insert 200 includes a body portion 202. Body portion 202 includes a first channel 204 that extends through insert 200 along a longitudinal axis of insert 200. First channel 204 is configured to receive a bundle of the plurality of optical fibers 24. In a specific embodiment, first channel 204 is a central channel.

Body 202 further includes a second channel 206 that extends through insert 200 along the longitudinal axis of insert 200. Second channel 206 is configured to receive an access feature 36. Second channel 206 extends in generally parallel orientation to first channel 204 and is spaced apart (i.e., not connected) from first channel 204. In other words, second channel 206 is not collinear with first channel 204. The separation between the first channel 204 and the second channel 206 creates the separation between the bundled plurality of optical fibers 24 and access feature 36 that prevents the access feature 36 and optical fibers 24 from becoming entangled during the extrusion process. In embodiments in which multiple access features 36 are provided, the body 202 includes as many second channels 206 as access features 36. In one or more embodiments with two rip cords 36, the second channels 206 are substantially equidistantly spaced around first channel 204. During extrusion of the membrane 26, molten polymer material is extruded around the insert 200 within the extrusion tip.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more than one component or element, and is not intended to be construed as meaning only one.

It will be apparent to those skilled in the art that various modifications and variations can be made without departing from the spirit or scope of the disclosed embodiments. Since modifications, combinations, sub-combinations and variations of the disclosed embodiments incorporating the spirit and substance of the embodiments may occur to persons skilled in the art, the disclosed embodiments should be construed to include everything within the scope of the appended claims and their equivalents.

What is claimed is:

1. An optical fiber subunit, comprising:
a membrane comprising:
an inner surface, the inner surface defining a central passage that extends along a longitudinal axis of the optical fiber subunit; and
an outer surface;
at least one optical fiber disposed in the central passage such that the membrane surrounds the at least one optical fiber; and
an access feature extending along the longitudinal axis of the optical fiber subunit, the access feature disposed in the central passage and attached to the inner surface of the membrane.

2. The optical fiber subunit of claim 1, wherein the access feature includes a coating along at least a portion of a length of the access feature to enhance attachment of the access feature to the membrane.

3. The optical fiber subunit of claim 2, wherein the coating comprises an elastomeric copolymer.

4. The optical fiber subunit of claim 3, wherein the membrane comprises a polyethylene material.

5. The optical fiber subunit of claim 1, wherein the access feature is formed from a low shrink material.

6. The optical fiber subunit of claim 5, wherein the access feature is formed from at least one of ultra-low shrink polyester, ultra high molecular weight polyethylene, an aramid, a liquid crystal polymer, E-glass, or basalt.

7. The optical fiber subunit of claim 1, further comprising at least one further access feature, the at least one further access feature extending along the longitudinal axis of the optical fiber subunit and the at least one further access feature being disposed in the central passage and attached to the inner surface of the membrane.

8. The optical fiber subunit of claim 1, further comprising a second access feature, wherein the access feature and the second access feature are substantially equidistantly spaced around the inner surface of the membrane.

9. The optical fiber subunit of claim 1, wherein the membrane is transparent or translucent and the access feature is colored.

10. The optical fiber subunit of claim 1, wherein a maximum thickness of the membrane is defined between the inner surface and the outer surface, the maximum thickness being 0.12 mm or less.

11. The optical fiber subunit of claim 1, wherein the access feature has an elastic modulus greater than 2 GPa.

12. An optical fiber cable, comprising:
a cable jacket comprising:
an exterior surface, the exterior surface defining an outermost surface of the optical fiber cable; and
an interior surface, the interior surface defining a central bore extending along a longitudinal axis of the optical fiber cable; and
at least one subunit disposed within the central bore, each of the at least one subunit comprising:
a membrane comprising:
an inner surface defining a central passage that extends along the longitudinal axis of the optical fiber cable; and
an outer surface;
at least one optical fiber; and
an access feature;
wherein the at least one optical fiber and the access feature are disposed in the central passage such that the membrane surrounds the at least one optical fiber and the access feature, and wherein the access feature is attached to the membrane.

13. The optical fiber cable of claim 12, wherein the access feature comprises a coating to facilitate attachment of the access feature to the membrane.

14. The optical fiber cable of claim 13, wherein the coating comprises one of ethylene acrylic acid, ethylene vinyl acid copolymers, or a mixture of ethylene acrylic acid and ethylene vinyl acid copolymers.

15. The optical fiber cable of claim 12, wherein the access feature is formed from at least one of ultra-low shrink polyester, ultra high molecular weight polyethylene, an aramid, a liquid crystal polymer, E-glass, or basalt.

16. The optical fiber cable of claim 12, wherein the access feature has a tensile strength in a range of 20 MPa to 120 MPa.

17. The optical fiber cable of claim 12, wherein the membrane further comprises a plurality of access features, each access feature extending along the longitudinal axis of the optical fiber cable and bonded to the inner surface of the membrane.

18. The optical fiber cable of claim 12, wherein a thickness of the membrane is defined between the inner surface and the outer surface, the thickness being 0.12 mm or less.

19. The optical fiber cable of claim 12, further comprising a plurality of subunits positioned within the central bore.
